(19) United States
(12) Patent Application Publication
(10) Pub. No.: US 2026/0003618 A1
(43) Pub. Date: Jan. 1, 2026

(54) PREFETCHING AN ACCESS PATTERN HAVING A JUMP

(71) Applicant: QUALCOMM Incorporated, San Diego, CA (US)

(72) Inventors: Jungsoo KIM, Sawston (GB); Sabine FRANCIS, Austin, TX (US); Conrado BLASCO, San Mateo, CA (US)

(21) Appl. No.: 18/642,516

(22) Filed: Apr. 22, 2024

(51) Int. Cl. G06F 9/30; G06F 9/38

(52) U.S. Cl. CPC G06F 9/30047; G06F 9/3802

(57) ABSTRACT

Certain aspects of the present disclosure provide techniques and apparatus for prefetching an access pattern having a jump. Aspects include obtaining a stride between consecutive memory accesses of the access pattern to determine a stride pattern for the access pattern. Aspects include determining whether a jump in the access pattern has occurred based on the stride pattern and a current stride of the access pattern. Aspects include, in response to determining the jump in the access pattern has occurred, adjusting a prefetch address for a next memory access of the access pattern based on the jump in the access pattern. Aspects include issuing a prefetch request for the adjusted prefetch address.

### TECHNICAL FIELD

Aspects of the present disclosure generally relate to prefetchers and, more particularly, to techniques for prefetching an access pattern having a jump, such as a two-dimensional (2D) access pattern having multiple rows delineated by the jump.

### BACKGROUND

A processing system typically includes a central processing unit (CPU), cache memory, main memory (e.g., random access memory), and a prefetcher. The prefetcher anticipates data (and/or instructions) the CPU may need from the main memory, fetches the data from the main memory, and loads the data into the cache memory. By fetching the data from the main memory before the data is needed by the CPU, the prefetcher minimizes an amount of time the CPU has to wait for data thereby improving the efficiency of the processing system.

### BRIEF SUMMARY

Certain aspects provide a method for prefetching an access pattern, comprising: obtaining a stride between consecutive memory accesses of the access pattern to determine a stride pattern for the access pattern; determining whether a jump in the access pattern has occurred based on the stride pattern and a current stride of the access pattern; in response to determining the jump in the access pattern has occurred, adjusting a prefetch address for a next memory access of the access pattern based on the jump in the access pattern; and issuing a prefetch request for the adjusted prefetch address.

Other aspects provide a processor comprising a prefetcher configured to perform the aforementioned method as well as those described herein; and a processor comprising means for performing the aforementioned method as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts an example computing environment for prefetching an access pattern according to various aspects of the present disclosure.

FIG. 2 depicts an example access pattern having a jump according to various aspects of the present disclosure.

FIG. 3 depicts a technique for prefetching an access pattern having a jump according to various aspects of the present disclosure.

FIG. 4 depicts a method for prefetching an access pattern having a jump according to various aspects of the present disclosure.

FIG. 5 depicts a method for determining a jump in an access pattern according to various aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for prefetching access patterns having a jump.

The CPU of a processing system may execute a program that includes a sequence of memory accesses. The sequence of memory accesses may generally be referred to as an access pattern, and prefetchers of the processing system may target specific access patterns. For example, a first class of prefetchers includes stride prefetchers and stream prefetchers that target access patterns having a uniform stride. As used herein, a stride of an access pattern may refer to a difference between memory addresses associated with consecutive memory accesses of the access pattern. A second class of prefetchers includes variable length delta prefetchers that target access patterns having repeating deltas.

However, typical prefetchers may be challenged to capture more complex access patterns, such as a 2D access pattern having multiple rows delineated by a jump. More specifically, typical prefetchers may be challenged to detect the jump in the 2D access pattern and, as a result, may continue to perform prefetches according to a stride pattern of the 2D access pattern before the jump. This results in prefetchers performing prefetches that are not part of the 2D access pattern. These prefetches that are not part of the 2D access pattern may be referred to as useless prefetches, and these useless prefetches may lead to cache misses causing diminished performance of the processing system. As used herein, a cache miss refers to an instance in which the CPU requests data that is not yet loaded into the cache memory and therefore results in the CPU having to wait while the prefetcher fetches the requested data.

Certain aspects of the present disclosure are generally directed to techniques for prefetching an access pattern having a jump. More specifically, aspects of the disclosed techniques are directed to detecting the jump in the access pattern and adjusting a prefetch address for a next memory access in the access pattern based on the detected jump in the access pattern. Accordingly, the disclosed techniques generally allow prefetchers to more efficiently capture complex access patterns because, by adjusting the prefetch address based on detected jumps in access patterns, the disclosed techniques minimize useless prefetches (e.g., memory accesses not associated with the access pattern) that pollute the cache memory and, as mentioned above, lead to cache misses (e.g., instances in which instructions requested by the CPU are not yet loaded into the cache memory) resulting in diminished performance (e.g., efficiency) of the CPU.

### Example Computing Environment for Prefetching

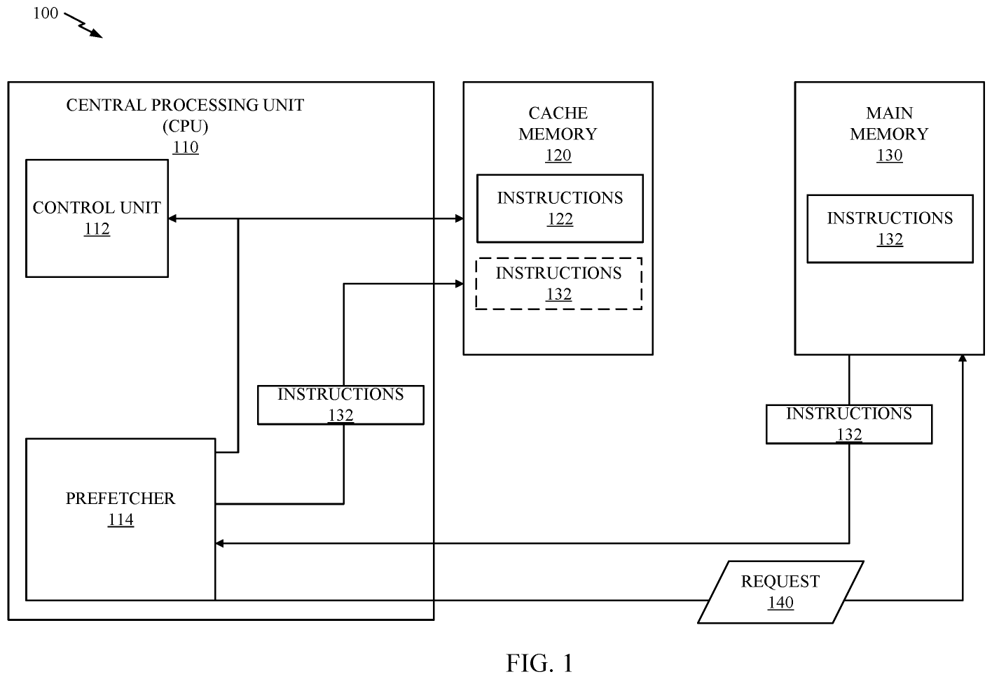

FIG. 1 illustrates an example computing environment 100 for prefetching according to various aspects of the present disclosure. The computing environment 100 includes a central processing unit (CPU) 110 configured to execute instructions to perform various computing operations. The CPU 110 may include a control unit 112 and a prefetcher 114.

The computing environment 100 includes a cache memory 120 communicatively coupled to the CPU 110. The cache memory 120 may store instructions 122 to be executed by the CPU 110. Although the cache memory 120 is depicted as being separate from the CPU 110, the cache memory 120 may, in some aspects, be included as part of the CPU 110.

The computing environment 100 includes a main memory 130. The main memory 130 is slower than the cache memory 120 and is configured to store instructions 132 to be executed by the CPU 110. In certain aspects, the main memory 130 may include random access memory (RAM).

The prefetcher 114 of the CPU 110 is configured to anticipate instructions, such as the instructions 132 stored in the main memory 130, that are needed by the CPU 110, such as the control unit 112 thereof, and are not already loaded into the cache memory 120. The prefetcher 114 may be further configured to fetch the instructions 132 from the main memory 130 and load the instructions 132 into the cache memory 120 before the instructions 132 are needed by the CPU 110.

As an example, a prefetch operation performed by the prefetcher 114 may include the prefetcher 114 requesting the instructions 132 from the main memory 130 (e.g., by sending a prefetch request 140). The prefetcher operation may include receiving the instructions 132 from the main memory 130 and loading the instructions 132 into the cache memory 120. By fetching the instructions 132 from the main memory 130 and loading the instructions 132 into the cache memory 120 before the instructions 132 are needed by the CPU 110, the prefetcher 114 minimizes an amount of time the CPU 110 has to wait for the instructions 132 thereby improving the efficiency of the CPU 110.

In certain aspects, the instructions 132 stored on the main memory 130 may include multiple instructions stored at different memory addresses of the main memory 130. For example, a first instruction for the control unit 112 may be stored at a first memory address of the main memory 130, and a second instruction for the control unit 112 may be stored at a second memory address of the main memory 130. In such aspects, the prefetcher 114 may be configured to perform separate prefetch operations for the first instruction and the second instruction.

As an example, a first prefetch operation performed by the prefetcher 114 may include sending a request to read the data (e.g., first instruction) stored at the first memory address to obtain the first instruction. In this manner, the prefetcher 114 may obtain the first instruction to load into the cache memory 120. Furthermore, a second prefetch operation performed by the prefetcher 114 may include sending a request to read the data (e.g., second instruction) stored at the second memory address to obtain the second instruction. In this manner, the prefetcher 114 may obtain the second instruction to load into the cache memory 120.

### Example Access Pattern Having a Jump

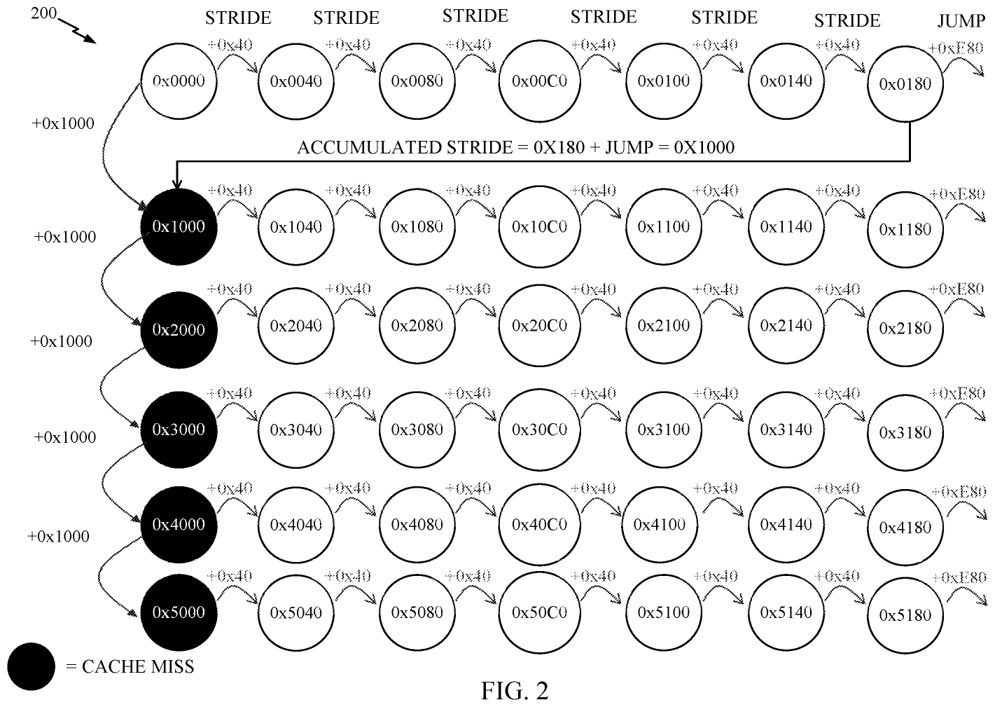

FIG. 2 is a diagram depicting an example complex access pattern 200 that may be fetched by a prefetcher (such as the prefetcher 114 illustrated in FIG. 1) according to certain aspects of the present disclosure. As shown, the access pattern 200 may be a 2D access pattern having multiple rows. The rows of the access pattern 200 may be delineated by a jump in the access pattern 200. As shown, the jump in the access pattern 200 illustrated in FIG. 2 has a value of 0xE80.

The access pattern 200 may begin at an initial memory address (e.g., 0x0000). The initial memory address may store data that the prefetcher accesses or, alternatively, the initial memory address may simply be a starting point for the prefetcher. From the initial memory address, the prefetcher may proceed to access memory addresses according to a stride pattern which, for the access pattern 200 of FIG. 2, is a constant stride of 0x40. However, in alternative aspects, the stride pattern may not be a constant stride. Instead, the stride pattern may be an alternating stride pattern that includes multiple different strides occurring in some defined pattern. It should be understood that the term “stride pattern” as used herein refers to an array of accumulated strides, with each stride indicating a difference between consecutive memory addresses in the access pattern.

The end (e.g., the last memory address) of each row of the access pattern 200 may include the jump, which deviates from the stride pattern of the access pattern 200 and represents a transition from a current row of the access pattern 200 to a next row of the access pattern 200. More particularly, the jump may correspond to a difference between the last memory address of the current row and the initial memory address of the next row of the access pattern 200. As an example, the jump from the current row (e.g., starting at 0x0000 and ending at 0x0180) of the access pattern 200 to the next row (e.g., starting at 0x1000 and ending at 0x1180) of the access pattern 200 may correspond to a resultant of the initial memory address (e.g., 0x1000) of the next row minus the last memory address (e.g., 0x0180) of the current row. Thus, for the access pattern 200 of FIG. 2, the jump from the current row of the access pattern 200 to the next row of the access pattern 200 may, as mentioned above, correspond to the hex value 0x0E80.

As previously mentioned, a prefetcher implementing conventional techniques for prefetching access patterns, such as the access pattern 200 of FIG. 2, typically ignores the jump (e.g., +0xE80) in the access pattern 200 and continues to perform memory accesses according to the stride pattern of the access pattern 200. Using the access pattern 200 of FIG. 2 as an example, the prefetcher implementing conventional techniques would ignore the jump (e.g., 0xE80) from an initial row (e.g., ending with memory address 0x0180) of the access pattern 200 to a next row (e.g., starting with memory address 0x1000) of the access pattern 200 and instead would continue performing prefetches at the uniform stride (e.g., 0x40). As a result, the prefetcher implementing conventional techniques for prefetching access patterns would access data stored at multiple memory addresses that are not included in the access pattern 200. For example, after prefetching the data stored at memory address 0x0180 denoting the end of the initial row of the access pattern 200, the prefetcher implementing conventional techniques for prefetching would access data at memory address 0x01C0 and so forth according to the uniform stride (e.g., 0x40) until the prefetcher eventually reached memory address 0x1000 denoting the beginning of the next row of the access pattern 200.

These useless prefetches delay the prefetcher from accessing data stored at the initial memory address of the next row of the access pattern 200 such that the prefetcher does not load the data into cache memory (e.g., the cache memory 120 illustrated in FIG. 1) before the CPU (e.g., the CPU 110 illustrated in FIG. 1) attempts to fetch the data from the cache memory. As a result, a cache miss 210 (e.g., denoted by solid black circle) occurs at the beginning of the next row of the access pattern 200. Furthermore, as illustrated in FIG. 2, the cache miss 210 continues to occur at the beginning of every subsequent row included in the access pattern 200, because the prefetcher implementing the conventional techniques for prefetching continues to ignore the jump in the access pattern 200. These cache misses 210 lead to diminished performance (e.g., efficiency) of the CPU, because the CPU must wait for the prefetcher to fetch the data stored at the initial memory address of the current row of the access pattern 200.

### Example Technique for Prefetching an Access Pattern Having a Jump

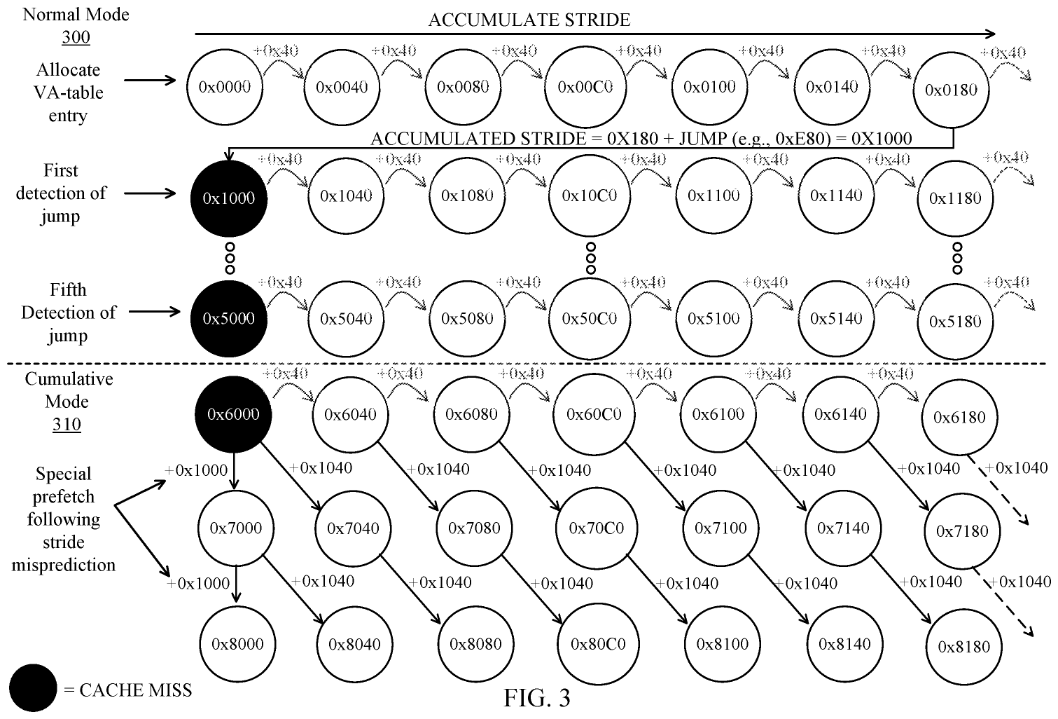

FIG. 3 illustrates a technique for prefetching an access pattern having a jump, such as the access pattern 200 of FIG. 2, according to certain aspects of the present disclosure. The technique may include two modes, a normal mode 300 in which the jump (e.g., 0xE80) is detected multiple times (e.g., 5 or more) without altering the prefetching to account for the jump and a cumulative mode 310 in which the prefetching is altered according to the detected jump in the access pattern 200 to therefore capture the access pattern 200 in a more efficient manner (e.g., no cache misses). Details of the normal mode 300 and the cumulative mode 310 will now be discussed in detail.

While operating in the normal mode 300, a stride pattern of the access pattern 200 is determined based, at least in part, on a threshold number of instances (e.g., at least two) of the stride of the access pattern 200. As shown, the stride of the access pattern 200 may be constant (e.g., 0x40) up to the jump in the access pattern 200 and therefore the stride pattern of the access pattern 200 up to the jump may be uniform (e.g., constant stride). However, in some aspects, the stride of the access pattern 200 may be non-uniform (e.g., alternating between a first stride and a second stride) up to the jump and therefore the stride pattern of the access pattern 200 up to the jump may be non-uniform.

Once the stride pattern of the access pattern 200 has been determined during the normal mode 300, a current stride of the access pattern 200 may be compared to an expected stride of the access pattern 200 according to the determined stride pattern. If the current stride of the access pattern 200 matches the expected stride of the access pattern 200, prefetches continue according to the stride pattern. If, however, the current stride of the access pattern 200 does not match the expected stride of the access pattern 200, the current stride of the access pattern 200 may need to be evaluated to determine whether a jump in the access pattern 200 has occurred.

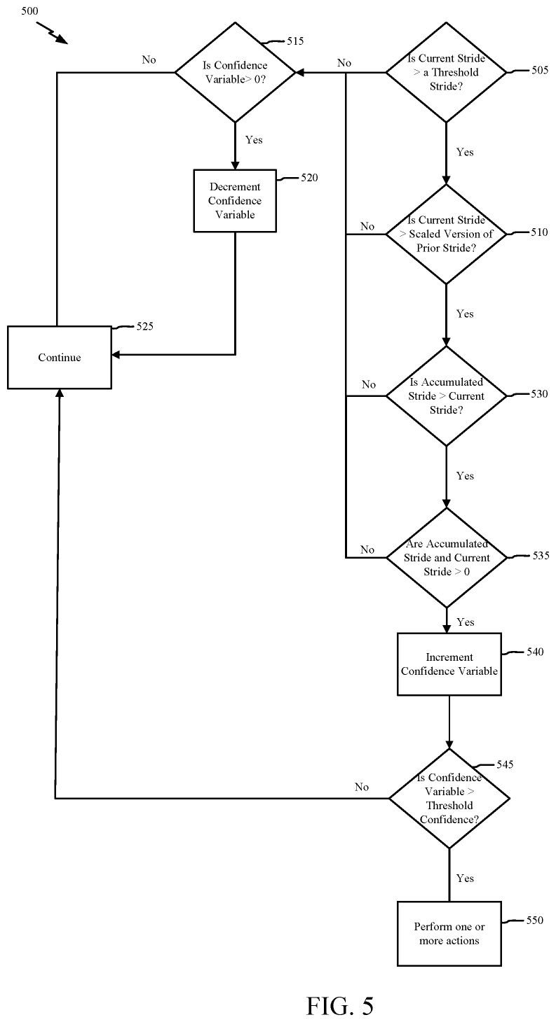

When the current stride of the access pattern 200 deviates from the expected stride while the prefetcher is operating in the normal mode 300, prefetches are not adjusted and instead continue according to the uniform stride (e.g., 0x40) because the access pattern 200 cannot yet be confirmed as a complex access pattern (e.g., 2D pattern) having a defined jump. In addition, the disclosed technique for prefetching the access pattern 200 can include, as illustrated in FIG. 5 in more detail, confirming various preconditions are satisfied in order to confirm the jump in the access pattern 200.

In certain aspects, a first precondition may be that the current stride (e.g., jump) of the access pattern 200 is greater than a threshold stride. A second precondition may be that the current stride of the access pattern 200 is greater than a scaled version of a prior stride of the access pattern 200. More specifically, the prior stride may be the stride of the access pattern immediately prior to the jump (e.g., current stride) in the access pattern 200. Furthermore, the scaled version of the prior stride may be the resultant of the prior stride multiplied by an integer. A third precondition may be that the accumulated stride of the access pattern 200 is greater than the current stride of the access pattern 200, with the accumulated stride corresponding to the sum of every stride of the access pattern 200 thus far (e.g., including the current stride of the access pattern 200). A fourth precondition may be that the current stride of the access pattern 200 and the accumulated stride of the access pattern 200 are both positive (e.g., greater than 0). In some aspects, a fifth precondition may be that a difference between the accumulated stride of the access pattern 200 and an accumulated stride of the access pattern 200 immediately prior to adding the current stride of the access pattern 200 is within a threshold (e.g., less than 5 percent).

In certain aspects, one or more of the above-mentioned preconditions may be used for heuristics. In particular, the precondition(s) may be used to ensure the current stride of the access pattern 200 is not out-of-order (e.g., a lower memory address than the most recent memory address accessed in the access pattern) and therefore not a jump in the access pattern 200. For example, the third precondition, the fourth precondition, or both may be used to confirm the current stride of the access pattern 200 is not out-of-order. If each of these preconditions is satisfied, a jump in the access pattern 200 may be confirmed.

In some aspects, an initial instance of the jump in the access pattern 200 may be confirmed if the current stride (e.g., the jump) of the access pattern 200 satisfies the above-mentioned preconditions. Once the initial instance of the jump in the access pattern 200 is confirmed, a confidence variable may be incremented. Furthermore, the confidence variable may be incremented for each confirmed subsequent jump in the access pattern 200. For instance, the confidence variable may be initialized to 0 and may be incremented by 1 for each confirmed jump in the access pattern. In some aspects, the confidence variable may be decremented if the current stride associated with a current instance of the jump fails to satisfy one or more of the above-mentioned preconditions and is therefore not indicative of a jump in the access pattern 200. Once a threshold number of instances (e.g., at least 5) of the jump in the access pattern 200 have been confirmed, the access pattern 200 may be confirmed as an access pattern (e.g., 2D access pattern) having a jump and, at this point, a prefetcher implementing the disclosed technique may transition from the normal mode 300 of the disclosed technique for performing prefetches to the cumulative mode 310 of the disclosed technique for performing prefetches to therefore capture the access pattern 200 in a more efficient manner (e.g., with less cache misses).

As shown, upon entering the cumulative mode 310, the access pattern 200 may be captured in a more efficient manner. For instance, in the cumulative mode 310, the prefetch address may be adjusted according to the accumulated stride (e.g., 0x1000) that is indicative of the determined jump in the access pattern 200. For example, instead of prefetching at the uniform stride of 0x40 like in the normal mode 300, prefetches performed in the cumulative mode may be performed at a stride of 0x1040 (that is, the sum of 0x40 and 0x1000). In this manner, the prefetcher may skip ahead and fetch subsequent rows (e.g., seventh row, eight row) of the access pattern 200 before the data stored at memory addresses included in those subsequent rows is requested by the CPU. Accordingly, cache misses may be avoided, such as the cache miss that occurs at the beginning of each of the first several rows of the access pattern 200 that are fetched in the normal mode 300.

In some aspects, special prefetches may be performed during the cumulative mode 310. For instance, as illustrated in FIG. 3, a stride misprediction may occur at some point during prefetching of the access pattern 200, such as when prefetching the sixth row of the access pattern 200. In response to the stride misprediction, the disclosed technique may include resetting the stride to the accumulated stride (e.g., 0x1000) associated with the jump and issuing special prefetches at the beginning of the current row of the access pattern 200 and one or more subsequent rows of the access pattern 200 while in the cumulative mode 310.

### Example Method for Prefetching an Access Pattern Having a Jump

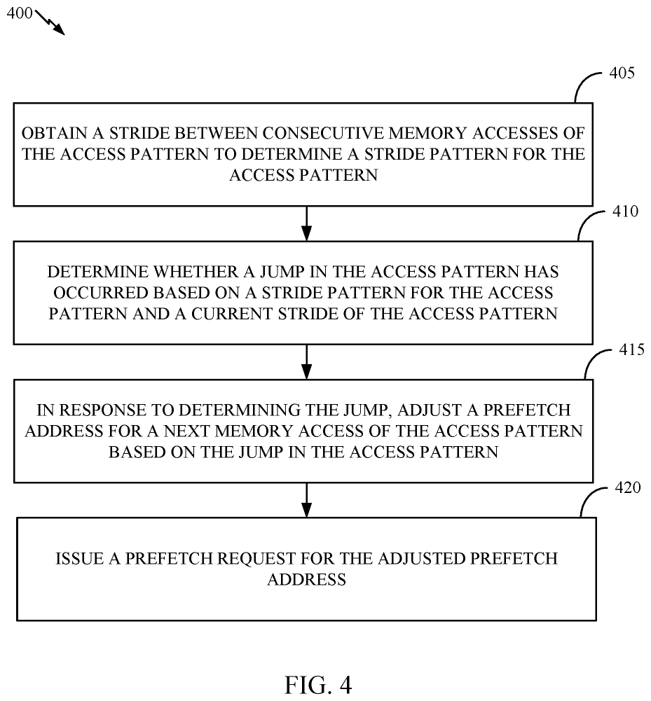

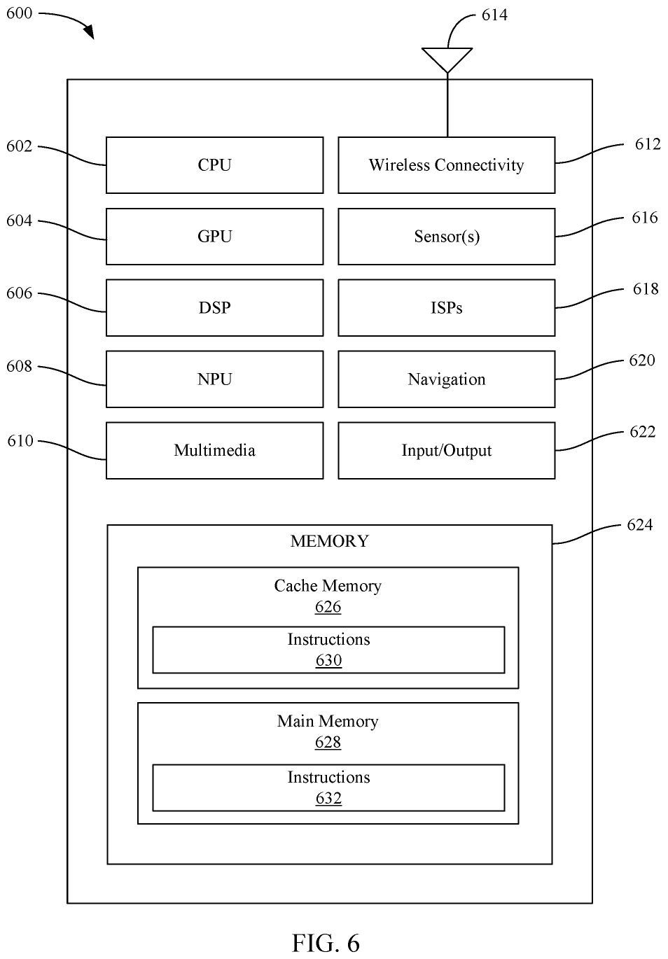

FIG. 4 is a diagram depicting an example method 400 for prefetching an access pattern having a jump, according to various aspects of the present disclosure. For example, method 400 may be performed by the prefetcher 114 of FIG. 1 and/or by a processing system such as processing system 600 of FIG. 6, described below.

Method 400 begins at block 405, with obtaining a stride between consecutive memory accesses of the access pattern to determine a stride pattern for the access pattern. For instance, a threshold number of instances (e.g., at least two) of a stride of the access pattern may be accumulated to determine the stride pattern of the access pattern. The stride of the access pattern may refer to a difference between memory addresses associated with consecutive memory accesses of the access pattern. For example, an initial stride of the access pattern may correspond to the difference between a memory address associated with an initial memory access of the access pattern and a memory address associated with an additional memory access of the access pattern that immediately follows the initial memory access. The stride of the access pattern may be accumulated each time the prefetcher performs a memory access.

In some instances, the stride of the access pattern may be constant up to the jump in the access pattern and therefore the stride pattern of the access pattern up to the jump may be uniform (e.g., constant stride). In other instances, the stride of the access pattern may be non-uniform (e.g., alternating between a first stride and a second stride) up to the jump and therefore the stride pattern of the access pattern up to the jump may be non-uniform.

Method 400 continues at block 410, with determining whether a jump in the access pattern has occurred based on the stride pattern and a current stride of the access pattern. In some aspects, a determination of whether a jump in the access pattern has occurred may include comparing a current stride of the access pattern to an expected stride of the access pattern based on the stride pattern determined at block 405. For example, a mismatch between the current stride of the access pattern and the expected stride of the access pattern according to the stride pattern determined at block 405 may indicate a jump in the access pattern.

Method 400 continues at block 415, with, in response to determining a jump in the access pattern has occurred, adjusting a prefetch address for a next memory access of the access pattern. In certain aspects, the prefetch address may be adjusted to correspond to the accumulated stride of the access pattern so that the adjusted prefetch address is the memory address associated with the memory access that occurs after the jump in the access pattern.

For example, the access pattern may be a 2D access pattern, such as the access pattern 200 illustrated in FIGS. 2 and 3, having multiple rows delineated by a uniform jump, and the adjusted prefetch address may include an initial memory address on the next row of the 2D access pattern. Also, as shown in FIG. 3, the adjusted prefetch address may correspond to 0x1040 (e.g., the sum of the accumulated stride of 0x1000 indicative of the jump and the prior stride pattern of 0x40) so that the prefetcher may begin fetching data associated with memory addresses included in subsequent rows of the access pattern.

Method 400 continues at block 420, with, issuing a prefetch based on the adjusted prefetch address. More specifically, the prefetcher implementing the method 400 to capture the access pattern having the jump may perform a prefetch operation in which the prefetcher fetches data stored at a memory address corresponding to the adjusted prefetch address. Additionally, the prefetcher loads the data into cache memory (e.g, the cache memory 120 illustrated in FIG. 1) so that the data is available in the cache memory before the data is requested by the CPU (e.g., the CPU 110 illustrated in FIG. 1).

### Example Method for Determining a Jump in an Access Pattern

FIG. 5 is a diagram depicting an example method 500 for determining a jump in an access pattern, according to various aspects of the present disclosure. For example, method 500 may be performed by the prefetcher 114 of FIG. 1 and/or by a processing system such as processing system 600 of FIG. 6, described below. Furthermore, the method 500 of FIG. 5 may be implemented at block 410 of the method 400 discussed above with reference to FIG. 4. Also, although FIG. 5 depicts steps performed in a particular order for purposes of illustration and discussion, the method 500 discussed herein is not intended to be limited to any particular order or arrangement. One skilled in the art, using the disclosure provided herein, will appreciate that various steps of the method 500 can be omitted, rearranged, combined and/or adapted in various ways without deviating from the scope of the present disclosure.

Method 500 begins, at block 505, with determining whether a current stride of the access pattern is greater than a threshold stride. For example, the threshold stride may be a predefined threshold value that the current stride must be greater than in order for the analysis of whether the current stride of the access pattern is, in fact, a jump in the access pattern. If the current stride of the access pattern exceeds the threshold stride, method 500 proceeds to block 510. Otherwise, the method 500 proceeds to block 515.

At block 515, the method 500 includes determining whether a confidence variable associated with determining whether a jump in the access pattern has occurred is greater than zero. If the confidence variable is greater than zero, the method continues to block 520 where the confidence variable is decremented and then the method 500 continues to block 525. Otherwise, the method 500 bypasses block 520 and continues directly to block 525.

In certain aspects, the method 500, at block 525, reverts to block 505 when another prefetch operation associated with the access pattern is performed and the current stride of the access pattern is updated based on the most-recent prefetch operation.

At block 510, the current stride of the access pattern is compared to a scaled version of a prior stride of the access pattern that immediately preceded the current stride of the access pattern. If the current stride of the access pattern is greater than the scaled version of the prior stride, the method 500 continues to block 530. Otherwise, the method continues to block 515.

At block 530, the method 500 includes determining whether an accumulated stride of the access pattern is greater than the current stride of the access pattern. As previously mentioned, the accumulated stride of the access pattern corresponds to the sum of every stride of the access pattern thus far, including the current stride of the access pattern. If the accumulated stride of the access pattern is greater than the current stride of the access pattern, the method 500 proceeds to block 535. Otherwise, the method 500 continues to block 515.

At block 535, the method 500 includes determining whether the accumulated stride of the access pattern and the current stride of the access pattern are both positive. If both the accumulated stride and the current stride are greater than zero, the method 500 continues to block 540. Otherwise, the method 500 continues to block 515.

At block 540, the method 500 include incrementing the confidence variable associated with determining whether a jump in the access pattern has occurred to increase the confidence of the method 500. Furthermore, upon incrementing the confidence variable, the method 500 continues to block 545.

At block 545, the method 500 includes determining whether the incremented confidence variable is greater than a threshold value. The threshold value may be associated with a minimum level of confidence needed in order take one or more actions in response to confirming the jump in the access pattern. If the incremented confidence variable is greater than the threshold value, the method 500 continues to block 550.

For example, as illustrated in FIG. 3, some aspects of the present disclosure may require multiple instances (e.g., 5 or more) of the jump in the access pattern 200 to be detected before the method 500 continues to block 550. Otherwise, the method 500 continues to block 520.

At block 550, the method 500 includes taking one or more actions in response to determining a jump in the access pattern has occurred. For example, the access pattern may be the access pattern 200 illustrated in FIGS. 2 and 3 and the one or more actions may include transitioning from a normal mode (e.g, the normal mode 300 illustrated in FIG. 3) of prefetching to a cumulative mode (e.g., the cumulative mode 310 illustrated in FIG. 3) of prefetching in order to capture the access pattern 200 in a more efficient manner (e.g., with less cache misses) compared to conventional prefetching techniques. In the cumulative mode, the prefetch address for subsequent prefetches may be adjusted based on the accumulated stride (e.g., 0x1000) of the access pattern 200 that is indicative of the confirmed jump in the access pattern 200. In this manner, prefetchers implementing the method 500 of FIG. 5 may improve efficiency of the CPU, because the prefetchers may fetch complex access patterns, such as the access pattern 200 of FIG. 2, having a jump in a more efficient manner (e.g., without cache misses 210 at the beginning of each row).

### Example Processing System for Prefetching an Access Pattern Having a Jump

In some aspects, the techniques and methods described with reference to FIGS. 3-5 may be implemented on one or more devices or systems. FIG. 6 depicts an example processing system 600 configured to perform various aspects of the present disclosure, including, for example, the techniques and methods described with respect to FIGS. 3-5. In some aspects, the processing system 600 may correspond to the computing environment 100 of FIG. 1. Although depicted as a single system for conceptual clarity, in some aspects, as discussed above, the operations described below with respect to the processing system 600 may be distributed across any number of devices or systems.

The processing system 600 includes a central processing unit (CPU) 602 (e.g., corresponding to CPU 110 of FIG. 1). Instructions executed at the CPU 602 may be loaded, for example, from a cache memory 626 (e.g., corresponding to the cache memory 120 of FIG. 1) associated with the CPU 602.

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

The memory 624 may include cache memory 626 (e.g., corresponding to the cache memory 120 illustrated in FIG. 1). The memory 624 may also include main memory 628 (e.g., corresponding to the main memory 130 illustrated in FIG. 1). The cache memory 626 may include instructions 630 to be executed by the CPU 602. The main memory 628 also includes instructions 632 to be executed by the CPU 602. As discussed previously, a prefetcher (e.g, the prefetcher 114 illustrated in FIG. 1) may anticipate that the CPU 602 needs instructions 632 from the main memory 628 and may perform techniques, such as the method of FIGS. 4 and 5, to fetch the instructions 632 from the main memory 628 and load the instructions 632 into the cache memory 626 before the instructions 632 are requested by the CPU 602.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### EXAMPLE CLAUSES

Implementation examples are described in the following numbered clauses:
Clause 1: A method for prefetching an access pattern comprising: obtaining a stride between consecutive memory accesses of the access pattern to determine a stride pattern for the access pattern; determining whether a jump in the access pattern has occurred based on the stride pattern and a current stride of the access pattern; in response to determining the jump in the access pattern has occurred, adjusting a prefetch address for a next memory access of the access pattern based on the jump in the access pattern; and issuing a prefetch request for the adjusted prefetch address.
Clause 2: The method of Clause 1, wherein determining the jump in the access pattern has occurred comprises determining the current stride of the access pattern is greater than a threshold stride.
Clause 3: The method of Clause 2, wherein determining the jump in the access pattern has occurred further comprises determining the current stride is greater than a scaled version of a stride of the access pattern immediately prior to the current stride.
Clause 4: The method of Clause 2 or 3, wherein determining the jump in the access pattern has occurred further comprises determining whether an accumulated stride of the access pattern is greater than the current stride of the access pattern.
Clause 5: The method of any one of Clause 2-4, wherein determining the jump in the access pattern has occurred further comprises: determining the accumulated stride is positive; and determining the current stride is positive.
Clause 6: The method of any one of Clause 1-5, wherein the accumulated stride includes the current stride; and adjusting the prefetch address for a next memory access of the access pattern comprises adding the accumulated stride to a memory address associated with an initial memory access of the access pattern.
Clause 7: The method of any one of Clause 1-6, further comprising: in response to determining the jump in the access pattern has occurred, incrementing a confidence variable to indicate increased confidence in detecting jumps in the access pattern.
Clause 8: The method of Clause 7, further comprising: determining whether the confidence variable is greater than a threshold; and in response to determining the confidence variable is greater than the threshold, adjusting the prefetch address for the next memory access of the access pattern.
Clause 9: The method of Clause 7, further comprising: in response to determining the jump in the access pattern has not occurred, decrementing the confidence variable.
Clause 10: The method of any one of Clause 1-9, wherein: the access pattern comprises a two-dimensional access pattern having a plurality of rows; and the jump indicates a transition from a first row of the plurality of rows to a second row of the plurality of rows, the second row being immediately below the first row.
Clause 11: The method of Clause 10, wherein adjusting the prefetch address for the next memory access of the access pattern comprises adjusting the prefetch address to a memory address at a beginning of the second row.
Clause 12: A processor comprising: a prefetcher configured to execute computer-executable instructions to cause the prefetcher to: obtain a stride between consecutive memory accesses of an access pattern to determine a stride pattern for the access pattern; determine whether a jump in the access pattern has occurred based on the stride pattern and a current stride of the access pattern; in response to determining the jump in the access pattern has occurred, adjust a prefetch address for a next memory access of the access pattern based on the jump in the access pattern; and issue a prefetch request for the adjusted prefetch address.
Clause 13: The processor of Clause 12, wherein to determine the jump in the access pattern has occurred, the prefetcher is configured to determine the current stride of the access pattern is greater than a threshold stride.
Clause 14: The processor of Clause 13, wherein to determine the jump in the access pattern has occurred, the prefetcher is configured to determine the current stride is greater than a scaled version of a stride of the access pattern immediately prior to the current stride.
Clause 15: The processor of Clause 13 or 14, wherein to determine the jump in the access pattern has occurred, the prefetcher is configured to determine an accumulated stride of the access pattern is greater than the current stride of the access pattern.
Clause 16: The processor of any one of Clause 13-15, wherein to determine the jump in the access pattern has occurred, the prefetcher is configured to determine the accumulated stride is positive and determine whether the current stride is positive.
Clause 17: The processor of any one of Clause 13-16, wherein: the accumulated stride includes the current stride; and to adjust the prefetch address for a next memory access of the access pattern, the prefetcher is configured to add the accumulated to a memory address associated with an initial memory access of the access pattern.
Clause 18: The processor of any one of Clause 12-17, wherein the prefetcher is configured to: in response to determining the jump in the access pattern has occurred, increment a confidence variable to indicate increased confidence in detecting the jump in the access pattern.
Clause 19: The processor of Clause 18, wherein the prefetcher is further configured to: determine whether the confidence variable is greater than a threshold; and in response to determining the confidence variable is greater than the threshold, adjust the prefetch address for the next memory access of the access pattern.
Clause 20: An apparatus comprising: means for obtaining a stride between consecutive memory accesses of an access pattern to determine a stride pattern for the access pattern; means for determining whether a jump in the access pattern has occurred based on the stride pattern and a current stride of the access pattern; in response to determining the jump in the access pattern has occurred, means for adjusting a prefetch address for a next memory access of the access pattern based on the jump in the access pattern; and means for issuing a prefetch request for the adjusted prefetch address.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

For example, means for obtaining a stride between consecutive memory accesses of an access pattern to determine a stride pattern for the access pattern may include a prefetcher (e.g., pointer prefetcher 114 as illustrated in FIG. 1). Means for determining whether a jump in the access pattern has occurred based on the stride pattern and a current stride of the access pattern may include the prefetcher. Means for adjusting a prefetch address for a next memory access of the access pattern based on the jump in the access pattern may include the prefetcher. Means for issuing a prefetch request for the adjusted prefetch address may include the prefetcher.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for prefetching an access pattern, the method comprising:
obtaining a stride between consecutive memory accesses of the access pattern to determine a stride pattern for the access pattern;
determining whether a jump in the access pattern has occurred based on the stride pattern and a current stride of the access pattern;
in response to determining the jump in the access pattern has occurred, adjusting a prefetch address for a next memory access of the access pattern based on the jump in the access pattern; and
issuing a prefetch request for the adjusted prefetch address.

2. The method of claim 1, wherein determining the jump in the access pattern has occurred comprises determining the current stride of the access pattern is greater than a threshold stride.

3. The method of claim 2, wherein determining the jump in the access pattern has occurred further comprises determining the current stride is greater than a scaled version of a stride of the access pattern immediately prior to the current stride.

4. The method of claim 2, wherein determining the jump in the access pattern has occurred further comprises determining whether an accumulated stride of the access pattern is greater than the current stride of the access pattern.

5. The method of claim 2, wherein determining the jump in the access pattern has occurred further comprises:
determining an accumulated stride of the access pattern is positive; and
determining the current stride is positive.

6. The method of claim 1, wherein:
an accumulated stride of the access pattern includes the current stride; and
adjusting the prefetch address for a next memory access of the access pattern comprises adding the accumulated stride to a memory address associated with an initial memory access of the access pattern.

7. The method of claim 1, further comprising:
in response to determining the jump in the access pattern has occurred, incrementing a confidence variable to indicate increased confidence in detecting jumps in the access pattern.

8. The method of claim 7, further comprising:
determining whether the confidence variable is greater than a threshold; and
in response to determining the confidence variable is greater than the threshold, adjusting the prefetch address for the next memory access of the access pattern.

9. The method of claim 7, further comprising:
in response to determining the jump in the access pattern has not occurred, decrementing the confidence variable.

10. The method of claim 1, wherein:
the access pattern comprises a two-dimensional access pattern having a plurality of rows; and
the jump indicates a transition from a first row of the plurality of rows to a second row of the plurality of rows, the second row being immediately below the first row.

11. The method of claim 10, wherein adjusting the prefetch address for the next memory access of the access pattern comprises adjusting the prefetch address to a memory address at a beginning of the second row.

12. A processor comprising:
a prefetcher configured to execute computer-executable instructions to cause the prefetcher to:
obtain a stride between consecutive memory accesses of an access pattern to determine a stride pattern for the access pattern;
determine whether a jump in the access pattern has occurred based on the stride pattern and a current stride of the access pattern;
in response to determining the jump in the access pattern has occurred, adjust a prefetch address for a next memory access of the access pattern based on the jump in the access pattern; and
issue a prefetch request for the adjusted prefetch address.

13. The processor of claim 12, wherein to determine the jump in the access pattern has occurred, the prefetcher is configured to determine the current stride of the access pattern is greater than a threshold stride.

14. The processor of claim 13, wherein to determine the jump in the access pattern has occurred, the prefetcher is configured to determine the current stride is greater than a scaled version of a stride of the access pattern immediately prior to the current stride.

15. The processor of claim 13, wherein to determine the jump in the access pattern has occurred, the prefetcher is configured to determine an accumulated stride of the access pattern is greater than the current stride of the access pattern.

16. The processor of claim 13, wherein to determine the jump in the access pattern has occurred, the prefetcher is configured to determine an accumulated stride of the access pattern is positive and determine the current stride is positive.

17. The processor of claim 13, wherein:
an accumulated stride of the access pattern includes the current stride of the access pattern; and
to adjust the prefetch address for a next memory access of the access pattern, the prefetcher is configured to add the accumulated stride to a memory address associated with an initial memory access of the access pattern.

18. The processor of claim 12, wherein the prefetcher is configured to:
in response to determining the jump in the access pattern has occurred, increment a confidence variable to indicate increased confidence in detecting the jump in the access pattern.

19. The processor of claim 18, wherein the prefetcher is further configured to:
determine whether the confidence variable is greater than a threshold; and
in response to determining the confidence variable is greater than the threshold, adjust the prefetch address for the next memory access of the access pattern.

20. An apparatus comprising:
means for obtaining a stride between consecutive memory accesses of an access pattern to determine a stride pattern for the access pattern;
means for determining whether a jump in the access pattern has occurred based on the stride pattern and a current stride of the access pattern;
in response to determining the jump in the access pattern has occurred, means for adjusting a prefetch address for a next memory access of the access pattern based on the jump in the access pattern; and
means for issuing a prefetch request for the adjusted prefetch address.
